(19) United States
(12) Patent Application Publication
(10) Pub. No.: US 2020/0287302 A1
(43) Pub. Date: Sep. 10, 2020

(54) TERMINAL BLOCK FOR OVEN

(71) Applicant: Nan tong huaguan electric co.,Ltd, Nantong, Jiangsu (CN)

(72) Inventors: Changming SHEN, Nantong, Jiangsu (CN); Weihua DING, Nantong, Jiangsu (CN)

(21) Appl. No.: 16/766,709

(22) PCT Filed: Mar. 28, 2018
(86) PCT No.: PCT/CN2018/080805

§ 371 Date: May 25, 2020

(30) Foreign Application Priority Data
Mar. 27, 2018 (CN) 201810255721.5

(51) Int. Cl. H01R 9/24; F24C 7/08; H01R 4/38

(52) U.S. Cl. CPC H01R 9/2416; H01R 9/2483; H01R 4/38; F24C 7/08

(57) ABSTRACT

A terminal block for an oven, including a base, a terminal, a screw and a grounding copper sheet. A plurality of terminal mounting slots are provided evenly in the base along transverse direction. The middle or both sides of the terminal mounting slot are provided with retaining grooves penetrating the bottom of the base. An elastic buckle is provided at the upper portion of the retaining groove. The middle of the terminal is provided with a wire installation through hole which penetrates the both ends of the terminal mounted in the terminal mounting slot. The elastic buckle is pressed on the top of the terminal, the grounding copper sheet covers and fits the upper surface of the terminal and is fixedly connected by a number of screws. The screws pass through the top of the terminal and screw vertically into the wire installation through hole.

### CROSS REFERENCE TO RELATED APPLICATION

This application claims priority and rights of patent applications filed with the State Intellectual Property Office of China on Mar. 27, 2018, with patent application numbers of 201810255721.5, and the entire contents of which are incorporated herein by reference.

### TECHNICAL FILED

The present disclosure relates to a terminal block, in particular to a terminal block for an oven.

### BACKGROUND

In the power electronic distribution and wiring, when a group of functional equipment is connected with another group of functional equipment, it is necessary to use some special terminals, which are called terminal block when these terminals are combined. The function of the terminal block is to connect the lines of the two groups of equipment and play the role of signal (current and voltage) transmission. With the terminal block, the wiring is beautiful, the connection is reliable and the maintenance is convenient.

At present, it is generally used the terminal block in the oven for wiring connection, the connection between the base and the terminal is generally fixed by screws, which is inconvenient to install and remove, and the screws may be loose, thus causing the separation of the base and the terminal, and even causing damage to the oven.

### SUMMARY

In order to solve the above problems, the present disclosure is to provide a terminal block for an oven, which is simple and ingenious in design, can realize rapid assembly in production, quick wiring and removal in installation and maintenance, and is convenient and quick in use.

The technical solution of the present disclosure:

A terminal block for an oven, including a base, a terminal, a screw, and a grounding copper sheet, wherein a plurality of terminal mounting slots are provided evenly in the base along transverse direction, the upper sides of both sides of the terminal mounting slots are provided with an opening, and a wire insertion hole is opened at one end of the terminal mounting slot, and the wire insertion hole communicates with the opening; the terminal mounting slots are provided with retaining grooves at the middle of the both sides or at the both sides, the retaining grooves penetrate the bottom of the base, an elastic buckle is provided at the upper portion of the retaining groove; a wire installation through hole which penetrates the both ends of the terminal is provided in the middle of the terminal; the terminal is mounted in the terminal mounting slot; the wire insertion hole communicates with the wire installation through hole, and the elastic buckle is pressed on the top of the terminal; the grounding copper sheet covers and fits a upper surface of the terminal and is fixedly connected by a number of screws; the screws are distributed along the direction of the wire insertion hole, and the screws pass through the top of the terminal and screw vertically into the wire insertion hole, the wire passes through the wire insertion hole and enter into the wire installation through hole, and the roots of the screws are pressed against the wire. The terminal is put into the terminal mounting slot and press down until the elastic buckle in the retaining grooves presses on the terminal, and then the screws are tightly screwed to fix the grounding copper sheet to the terminal, such that the assembly of the terminal block is completed. By releasing of the screws and removing of the grounding copper sheet, and then toggling the elastic buckle, so that the elastic buckle is deformed inward to loosen the terminal, thereby the terminal can be easily taken out after loosening the terminal, which is convenient and quick to use.

To further improve and refine the above technical solutions, the screw is an integrated screw with a pad.

To further improve and refine the above technical solutions, the creepage distance specified by the safety regulations is maintained between the terminal mounting slots, so as to ensure that there is a sufficient spacing for wiring during the use of the terminal block. And the clearance is provided between the terminal mounting slots to provide a good ventilation condition.

To further improve and refine the above technical solutions, the number of the terminal mounting slots is set according to product design requirements.

To further improve and refine the above technical solutions, a reinforced connecting plate is longitudinally arranged in the clearance, and the top of the reinforced connecting plate is in an arc shape to make the product more beautiful, lighter and safer. At the same time, the reinforced connecting plate is configured to ensure the stability of the overall structure of the terminal block.

To further improve and refine the above technical solutions, the bottom of the base is hollowed out with a plurality of grooves, the grooves communicate with each other, and communicate with the retaining grooves, so as to enhance the heat dissipation effect.

To further improve and refine the above technical solutions, the overall dimension of the base are set according to product design requirements.

To further improve and refine the above technical solutions, the base is made of PC+10% glass fiber or other heat-resistant engineering plastics to enhance its heat resistant temperature and strength; the terminal is made of aluminum or copper, and the surface of the terminal is zinc-plated; the screw is made of standard carbon steel, and the surface of the screw is nickel-plated or zinc-plated, and quenched; the grounding copper sheet is made of red copper according to standard requirements, so that the overall performance of the terminal block is better, and the rated current is higher.

### BRIEF DESCRIPTION OF THE DRAWINGS

FIG. 1 is a front view of the terminal block for oven.

FIG. 2 is a top view of the terminal block for the oven.

FIG. 3 is a front view of the base.

FIG. 4 is a top view of the base.

FIG. 5 is a bottom view of the base.

FIG. 6 is a schematic diagram showing the structure of the terminal.

In the drawings, 01—base; 02—terminal; 03—screw; 04—grounding copper sheet; 05—terminal mounting slot; 06—opening, 07—wire insertion hole; 08—elastic buckle; 09—wire installation through hole; 10—clearance; 11—connecting plate.

### DETAILED DESCRIPTION OF THE EMBODIMENTS

### Embodiment

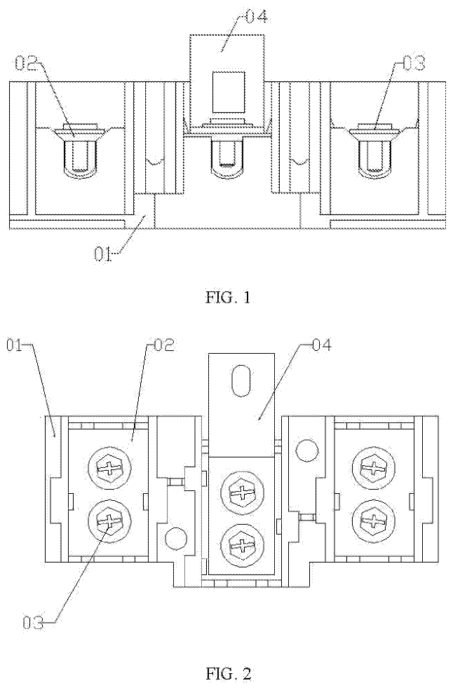

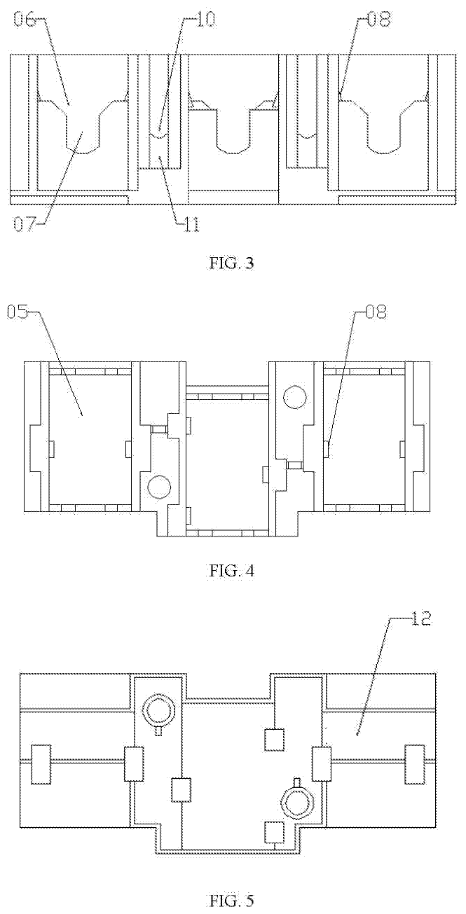

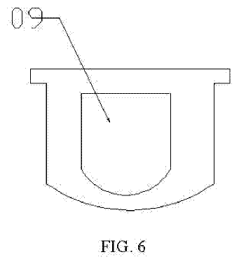

As shown in FIGS. 1-6, the terminal block for the oven includes base 01, terminal 02, screw 03 and grounding copper sheet 04. The shape of the base 01 is shown like the Chinese character “ [symbol] ”. There are three terminal mounting slots 05 evenly on the base 01 along the traverse direction. The upper sides of the both sides of the terminal mounting slots 05 are provided an openings 06, and one end of the terminal mounting slot 05 is provided with a wire insertion hole 07. The wire insertion hole 07 communicates with an opening 06, and the middle of the both sides or both sides of the terminal mounting slots 05 are provided with retaining grooves which penetrate through the bottom of the base 01, and the upper portion of the retaining groove is provided with an elastic buckle 08. The middle of the terminal 02 is provided with a wire installation through hole 09 which penetrate s through the both ends of the terminal. The terminal 02 is mounted in the mounting terminal mounting slot 05, the wire insertion hole 07 communicates with the wire installation through hole 09, and the elastic buckle 08 is pressed on the top of the terminal 02. The grounding copper sheet 04 covers and fits the upper surface of terminal 02 and is fixed connection by two screws 03. The screws 03 are evenly distributed along the direction of the wire installation through hole 09, and the screws 03 are vertically passed through the top of terminal 02 into the wire installation through hole 09. The wire enters into the wire installation through hole 09, and the roots of the screws 03 are pressed against the wire. The creepage distance specified in the safety specification is maintained between the terminal mounting slots 05 to effectively ensure the adjacent terminals 02 will not affect each other in extreme cases during the use of the terminal block. Besides, an clearance 10 is provided between the terminal mounting slots 05, which can provide a good ventilation condition. The clearance 10 is longitudinally provided with a reinforced connecting plate 11, which makes the product more beautiful and light, and the reinforced connecting plate 11 is used to ensure the stability of the overall structure of the terminal block. The bottom of the base 01 is hollowed out to design a number of grooves 12, and the grooves 12 communicate with each other, and further the grooves 12 communicate with the retaining grooves, so as to make the product more beautiful and light. The base 01 is made of PC+10% glass fiber or other heat-resistant engineering plastics to enhance its heat resistant temperature and strength. The terminal 02 is made of aluminum or copper, and the surface of the terminal is zinc-plated. The screw 03 is made of standard carbon steel, and the surface of the screw is nickel-plated or zinc-plated, and quenched. The grounding copper sheet is made of red copper according to standard requirements, so that the overall performance of the terminal block is better, and the rated current is higher.

Due to the limited expression of words, there are infinite concrete structures objectively. For those of ordinary skill in the art, without departing from the principles of the present disclosure, a number of improvements, modifications, or changes can be made, or the above technical features can be combined in an appropriate manner, those improvements, modifications, changes or combinations, or the application of the inventive concepts and technical solutions to other occasions without creative efforts should be regarded as the scope of the present disclosure.

What is claimed is:

1. A terminal block for an oven, comprising a base, a terminal, a screw, and a grounding copper sheet, wherein a plurality of terminal mounting slots are provided evenly in the base along transverse direction, upper sides of both sides of the plurality of terminal mounting slots are provided with an opening, and a wire insertion hole is opened at one end of the terminal mounting slot, and the wire insertion hole communicates with the opening; the plurality of terminal mounting slots are provided with retaining grooves at a middle of the both sides or at the both sides, the retaining grooves penetrate a bottom of the base, an elastic buckle is provided at a upper portion of the retaining groove; a wire installation through hole which penetrates the both ends of the terminal is provided in the middle of the terminal; the terminal is mounted in the terminal mounting slot; the wire insertion hole communicates with the wire installation through hole, and the elastic buckle is pressed on a top of the terminal; the grounding copper sheet covers and fits a upper surface of the terminal and is fixedly connected by a number of screws; the screws are distributed along a direction of the wire insertion hole, and the screws pass through a top of the terminal and screw vertically into the wire insertion hole, the wire passes through the wire insertion hole and enter into the wire installation through hole, and roots of the screws are pressed against the wire.

2. The terminal block for the oven according to claim 1, wherein the screw is an integrated screw with a pad.

3. The terminal block for the oven according to claim 2, wherein a creepage distance specified by the safety regulations is maintained between the plurality of terminal mounting slots, and an clearance is provided between the plurality of terminal mounting slots.

4. The terminal block for the oven according to claim 3, wherein the terminal block for the oven is provided between the clearance, wherein a reinforced connecting plate is longitudinally arranged in the clearance, and a top of the reinforced connecting plate is in an arc shape.

5. The terminal block for the oven according to claim 4, wherein a number of the plurality of terminal mounting slots is set according to product design requirements.

6. The terminal block for the oven according to claim 5, wherein the bottom of the base is hollowed out with a plurality of grooves, the grooves communicate with each other, and communicate with the retaining grooves.

7. The terminal block for the oven according to claim 6, wherein an overall dimension of the base are set according to product design requirements.

8. The terminal block for the oven according to claim 7, wherein the base is made of PC+10% glass fiber or other heat-resistant engineering plastics; the terminal is made of aluminum or copper, and a surface of the terminal is zinc-plated; the screw is made of standard carbon steel, and a surface of the screw is nickel-plated or zinc-plated, and quenched; the grounding copper sheet is made of red copper according to standard requirements.
